(19) United States
(12) Patent Application Publication
(10) Pub. No.: US 2005/0124733 A1
(43) Pub. Date: Jun. 9, 2005

(54) Process for working up polymer dispersions in polyesterpolyols

(75) Inventors: Hartmut Nefzger, Pulheim (DE); Eva Pischedda, Dormagen (DE); Erhard Michels, Koln (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/002,341

(22) Filed: Dec. 2, 2004

(30) Foreign Application Priority Data
Dec. 6, 2003 (DE) 10357160.4

(51) Int. Cl. C08K 3/00

(52) U.S. Cl. 523/340

(57) ABSTRACT

The present invention relates to a process for reducing the residual monomer content of polymer dispersions in polyester polyols.

### BACKGROUND OF THE INVENTION

The present invention provides a process for reducing the residual monomer content of polymer dispersions in polyesterpolyols.

Polymer dispersions in polyester polyols comprise a high molecular weight polymer or copolymer, a polyester polyol which is solid, or preferably liquid, at room temperature, and another modified polyester polyol required for phase stabilization purposes. The latter may make up from 0 to 100 wt. % of the total amount of polyol. As a result of the method of preparation, these types of polymer dispersions contain residual amounts of unreacted radically polymerizable monomers. The concentration of these monomers may be so great that odor problems can occur. In the extreme case, health-endangering concentrations may even be produced. Therefore, the residual monomer contents have to be adjusted to be as low as possible.

EP-A 259 537 discloses the post-addition of more than 85% of further radical initiators, after reaction of the radically polymerizable monomers, as this greatly improves conversion of the monomers, and as a result, reduces the residual monomer content. The disadvantage, however, apart from the raw material costs associated with the addition of more radial initiator, is the considerable increase in production time when practicing a procedure of this type.

EP-A 250 351 describes a process in which at least one ethlenically unsaturated monomer is polymerized in a polyester polyol having a molecular weight of 1,000 to 5,000 g/mol. The polyester polyol then contains, in addition to the conventional building blocks polycarboxylic acid and polyalcohol, also olefinic constituents, and in particular, the building block maleic anhydride. A vacuum is applied to remove unreacted radically polymerizable monomers. The effectiveness of this type of procedure is restricted due to the relatively high viscosity of dispersions based on polyester polyols. A lower residual content of unreacted radically polymerizable monomers is obtained at the cost of using relatively long production times.

### SUMMARY OF THE INVENTION

The object of the present invention is therefore to provide an improved process for reducing the residual monomer content in polymer dispersions based on polyester polyols. It has now been found that polymer dispersions with concentrations of unreacted radically polymerizable monomers of less than 20 ppm can be prepared by adding water as an entraining agent to the final dispersion per se, and then removing it again under vacuum. It is particularly surprising that the inherently hydrolysis-labile polyester polyols are not degraded by water treatment under these conditions.

The invention provides a process for reducing the residual monomer content of polymer dispersions in polyester polyols. This process comprises (a) adding an entraining agent comprising water, to the polymer dispersion, and (2) removing the water under reduced pressure.

In order to remove the unreacted radically polymerizable monomers, water is added. Water can be added either continuously or in portions, after the completion of free-radical polymerization at elevated temperature, preferably at 100° C. to 160° C., and at reduced pressure, preferably at 20 to 200 mbar. The water may be in either a liquid or gaseous (such as e.g. carrier steam) state of aggregation, and is particularly preferably introduced into the liquid polymer dispersion using a submerged tube, with stirring. In a preferred embodiment of the invention, water is added continuously or in portions for at least one hour, and continuously distilled off. The amount of water added is preferably from 2 to 10 wt. %, based on the total weight of the polymer dispersion. After completion of the addition procedure, the pressure is reduced to less than 20 mbar for at least 60 minutes, wherein the temperature is at least 100° C.

By using the process according to the invention, polymer dispersions can be obtained which have a concentration of unreacted radically polymerizable monomers of less than 20 ppm. The acid value of the polymer dispersion, which can be used as a measure of the hydrolysis of the base polyester polyols, is not increased by the process according to the invention. The polymer dispersions of the present invention generally have an acid value of less than 1 mg KOH/g of polymer dispersion even after treatment with water. Furthermore, the filterability and fine particle character of the polymer dispersion are also not impaired by the process according to the invention.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

A.) Base Polyester Polyols
B.) Modified Polyesterpolyols
C.) Preparation of Dispersions According to the Invention
D.) Comparison Examples
   A.) Preparation of the Base Polyester Polyols
   A.1. Base Polyester Polyol with a High Molecular Weight

This polyester polyol was prepared by slowly heating, to 200° C., 2779 g (26.22 mol) of diethylene glycol, 813 g (13.12 mol) of ethylene glycol and 5452 g (37.12 mol) of adipic acid with the elimination of water. When the formation of water had ended, the mixture was cooled to 120° C. and catalyzed with 180 mg of tin dichloride. The reaction mixture was heated slowly to 200° C. over the course of 4 hours under a water jet vacuum, with additional water being eliminated. The mixture was left under these reaction conditions for another 24 hours and the hydroxyl value of polyester polyol A.1. was then determined to be 27.8 mg KOH/g, and the acid value was 0.8 mg KOH/g.

A.2. Base Polyester Polyol with a Low Molecular Weight

Polyester polyol A.2. was prepared by slowly heating, to 200° C., 3177 g (29.97 mol) of diethylene glycol, 932 g (15.03 mol) of ethylene glycol and 5256 g (36 mol) of adipic acid, with the elimination of water. After the formation of water had ended, the mixture was cooled to 120° C. and catalyzed with 180 mg of tin dichloride. The reaction mixture was heated slowly to 200° C. over the course of 4 hours under a water jet vacuum, in which additional water was eliminated. The mixture was left under these reaction conditions for another 24 hours and the hydroxyl value of polyester polyol A.2. was then determined as 120.1 mg KOH/g, and the acid value was 0.3 mg KOH/g.

B.) Preparation of Modified Polyester Polyols

B.1. An Additive Containing Mercaptoacetic Acid (i.e. a Modified Polyester Polyol)

580 g (0.2 mol) of a polyadipate with the structural components diethylene glycol and TMP (trimethylolpropane) with a number average molecular weight of 2,900 g/mol and a functionality of about 3, 18.4 g (0.2 mol) of mercaptoacetic acid and 0.6 g of p-toluenesulfonic acid were dissolved in 100 ml of toluene. At a temperature of 140 to 145° C., 3.6 g (0.2 mol) of water was separated azeotropically in the water separator. Then, the toluene was distilled off. The OH value of this additive containing mercaptoacetic acid was determined to be 47.7 mg KOH/g, the acid value was 14.8 mg KOH/g, and the viscosity was 20,850 mPas (at 25° C.), or 4,020 mPas (at 50° C.).

C. Preparation of Dispersions According to the Invention

C.1. Preparation of a Polymer Dispersion having a Reduced Monomer Content

476 g of polyadipate polyester polyol A.1. were stirred up with 3 g of modified polyester polyol B.1., 100 g of toluene and 1 g of azo-bis-(2-methylbutyronitrile). A weak stream of nitrogen was passed through the solution for 20 min, 80 g of styrene were added and the mixture was heated to 80° C. over the course of 30 min, with stirring. After 20 min at 80° C., the temperature was increased to 120° C. over a further 30 min.

A previously prepared solution of 600 g of polyadipate polyester polyol A.1., 21 g of modified polyester polyol B.1., 200 g of toluene, 6.4 g of azo-bis-(2-methylbutyronitrile) and 800 g of styrene was metered in over the course of 2 hours at an initial speed of 300 rpm, wherein the speed was increased to 350 rpm after 20 min and to 400 rpm after a further 40 min. After completion of this metering process, the mixture was allowed to post-react for 5 min.

Another previously prepared solution of 38 g of polyadipate polyester polyol A.1., 4 g of modified polyesterpolyol B.1., 100 g of toluene and 0.6 g of azo-bis-(2-methylbutyronitrile) was then metered in over the course of 30 min. The mixture was left to post-react for 3 hours at 120° C. after completion of this addition process. Then, at 120° C., the pressure was gradually reduced from initially atmospheric pressure to less than 1 mbar, wherein toluene and unreacted styrene were largely removed. The batch was stirred for a further 3 hours at 120° C. and a pressure of less than 1 mbar. Over the course of 2 hrs., 150 ml of water were introduced via a submerged tube, wherein the pressure was 120 mbar and the temperature was 120° C. The mixture was then dewatered at 120° C. for 2 hours at a pressure of less than 15 mbar. The OH value of the product was determined to be 16.7 mg KOH/g. The polystyrene content of the dispersion was about 40 wt. % at this stage.

Next, 1119 g of polyadipate polyester polyol A.2. were stirred into this batch over 30 minutes. With the aid of a heatable nutsch filter, the still warm batch could be filtered through a 100 μm sieve within 5 minutes, without leaving a residue and without the application of pressure.

The OH value of the resultant polymer dispersion was 57.1 mg KOH/g, the acid value was 0.2 mg KOH/g and the viscosities at 25° C. and 50° C. were 30,520 and 6,040 mPas respectively. The solids content of the dispersion was 23.7 wt. %, and the free styrene content was 12 ppm.

D. Comparison Examples:

D.1. Toluene as an Agent for Reducing the Residual Monomer Content

476 g of polyadipate polyester polyol A.1. were stirred with 3 g of modified polyester polyol B.1., 100 g of toluene and 1 g of azo-bis-(2-methylbutyronitrile). A weak stream of nitrogen was passed through the solution for 20 min, 80 g of styrene were added and the mixture was heated to 80° C. over the course of 30 min, with stirring. After 20 min at 80° C., the temperature was raised to 120° C. over a further 30 min.

A previously prepared solution of 600 g of polyadipate polyester polyol A.1., 21 g of modified polyester polyol B.1., 200 g of toluene, 6.4 g of azo-bis-(2-methylbutyronitrile) and 800 g of styrene were metered in over the course of 2 hours at an initial speed of 300 rpm, wherein the speed was increased to 350 rpm after 20 min and to 400 rpm after a further 40 min. After completion of this metering process, the mixture was allowed to post-react for 5 min.

Another previously prepared solution of 38 g of polyadipate polyester polyol A.1., 4 g of modified polyester polyol B.1., 100 g of toluene and 0.6 g of azo-bis-(2-methylbutyronitrile) was then metered in over the course of 30 min. The mixture was left to post-react for 3 hours at 120° C. after completion of this addition process. Then, at 120° C., the pressure was gradually reduced from initially atmospheric pressure to <1 mbar, wherein toluene and unreacted styrene were largely removed. The batch was stirred for a further 3 hours at 120° C. and a pressure of <1 mbar. Over the course of 2 hours, 1 50 ml of toluene were introduced via a submerged tube, wherein the pressure was 120 mbar and the temperature was 120° C. Residual toluene was then removed at 120° C. for 2 hours at a pressure of <15 mbar. The OH value of the dispersion was determined to be 17.0 mg KOH/g. The polystyrene content of the dispersion was about 40 wt. % at this stage.

Next. 1167 g of polyadipate polyester polyol A.2. were stirred into this batch over 30 minutes. With the aid of a heatable nutsch filter, the still warm batch could be filtered through a 100 μm sieve within 5 minutes, without leaving a residue and without the application of pressure.

The OH value of the resultant polymer dispersion was 57.8 mg KOH/g, the acid value was 0.3 mg KOH/g, and the viscosities at 25° C. and 50° C. were 27,530 and 5,860 mPas, respectively. The solids content of the dispersion was 23.1 wt. %, and the free styrene content was 110 ppm.

D.2. Nitrogen as an Agent for Reducing the Residual Monomer Content

476 g of polyadipate polyester polyol A.1. were stirred up with 3 g of modified polyester polyol B.1., 100 g of toluene and 1 g of azo-bis-(2-methylbutyronitrile). A weak stream of nitrogen was passed through the solution for 20 min, 80 g of styrene were added and the mixture was heated to 80° C. over the course of 30 min, with stirring. After 20 min at 80° C., the temperature was raised to 120° C. over a further 30 min.

A previously prepared solution of 600 g of polyadipate polyester polyol A.1., 21 g of modified polyester polyol B.1., 200 g of toluene, 6.4 g of azo-bis-(2-methylbutyronitrile) and 800 g of styrene were metered in over the course of 2 hours at an initial speed of 300 rpm, wherein the speed was increased to 350 rpm after 20 min and to 400 rpm after a further 40 min. After completion of this metering process, the mixture was allowed to post-react for 5 min.

Another previously prepared solution of 38 g of polyadipate polyester polyol A.1., 4 g of modified polyester polyol B.1., 100 g of toluene and 0.6 g of azo-bis-(2-methylbutyronitrile) was then metered in over the course of 30 min. The mixture was left to post-react for 3 hours at 120° C. after completion of this addition process. Then, at 120° C., the pressure was gradually reduced from initially atmospheric pressure to <1 mbar, wherein toluene and unreacted styrene were largely removed. The batch was stirred for a further 3 hours at 120° C. and a pressure of <1 mbar. Over the course of 2 hours, a vigorous stream of nitrogen was introduced via a submerged tube, in such a way that the pressure was between 120 mbar and 200 mbar, wherein the temperature was held at 120° C. The OH value of the dispersion was determined to be 17.2 mg KOH/g. The polystyrene content of the dispersion was about 40 wt. % at this stage.

Next, 1199 g of polyadipate polyester polyol A.2. were stirred into this batch over 30 minutes. With the aid of a heatable nutsch filter, the still warm batch could be filtered through a 100 μm sieve within 5 minutes, without leaving a residue and without the application of pressure.

The OH value of the resultant polymer dispersion was 57.1 mg KOH/g, the acid value was 0.3 mg KOH/g, and the viscosities at 25° C. and 50° C. were 30,070 and 6,310 mPas, respectively. The solids content of the dispersion was 24.2 wt. %, and the free styrene content was 70 ppm.

D.3. Treatment of an Unfilled Polyesterpolyol with Water

500 g of a polyadipate polyester polyol with an OH value of 55.8 mg KOH/g and an acid value of 0.6 mg KOH/g were initially introduced, at 130° C. and with stirring, into a glass flask provided with a dropping funnel and distillation bridge. Over the course of 2 hours, 300 g of water were added at a pressure of 140 to 150 mbar, via the dropping funnel, wherein the greater part of the added water was immediately distilled off again. After completion of the addition of water, a high vacuum (<15 mbar) was applied for 1 hour to complete the removal of water. The acid value of the polyadipate polyester polyol was determined as 1.0 mg KOH/g.

The increase in acid value to 167% of the initial acid value demonstrates the inherent lability of polyester polyols under hydrolytic conditions. Surprisingly, this effect does not occur when the polyester polyols are present in the form of polymer dispersions.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for reducing the residual monomer content of polymer dispersions in polyester polyols comprising:
(1) adding an entraining agent comprising water to the polymer dispersion, and
(2) removing the water under reduced pressure.

2. The process of claim 1, in which water at 100° C. to 160° C. and at a pressure of 20 to 200 mbar is being continuously introduced into the polymer dispersion, and is continuously distilled off again.

3. The process of claim 1, in which the amount of water added to the polymer dispersion is from 2 to 10 wt. %, based on the total weight of the polymer dispersion.

4. The process of claim 1, in which, after completion of the addition of the water, the pressure over the polymer dispersion is reduced to less than 20 mbar for at least 60 minutes, and the temperature of the polymer dispersion during this time is at least 100° C.
